(19) United States
(12) Patent Application Publication
(10) Pub. No.: US 2024/0285099 A1
(43) Pub. Date: Aug. 29, 2024

(54) VISION MESH NETWORK FOR POINT-OF-SALE SYSTEMS

(71) Applicant: TOSHIBA GLOBAL COMMERCE SOLUTIONS, INC., DURHAM, NC (US)

(72) Inventors: JAMES L. FRANK, MONTREAL (CA); CHARLES RAY KIRK, RALEIGH, NC (US); JAMES WACHO SLAUGHTER, RALEIGH, NC (US); JUDITH L. ATALLAH, RALEIGH, NC (US); SRIJA GANGULY, RALEIGH, NC (US)

(21) Appl. No.: 18/173,900

(22) Filed: Feb. 24, 2023

(51) Int. Cl. A47F 9/04; G06V 20/52

(52) U.S. Cl. CPC A47F 9/048; G06V 20/52; G06V 2201/07

(57) ABSTRACT

A point-of-sale system is provided and includes a first checkout station and associated first edge cameras. The first cameras have a primary viewing area within the first checkout station and a peripheral viewing area outside the first checkout station. The system includes a second checkout station near the first checkout station and associated second edge cameras. The second cameras have a primary viewing area within the second checkout station and a peripheral viewing area outside the second checkout station. The peripheral viewing area of one second camera is within the first checkout station. The system further includes a vision mesh network having nodes in communication with each other. Some of the first and second cameras are nodes on the vision mesh network. A first edge camera receives and processes information about the first checkout station from the at least one second camera. A method is also provided.

### BACKGROUND

Self-checkout systems are commonly used by consumers at retail locations such as grocery stores. In operation, the user can scan items at the self-checkout system and place the scanned items on a scale and conveyor of the self-checkout system. When the item is scanned, the self-checkout system accesses data that indicates information about the scanned item, such as a specified weight and verifies that the scanned items are the ones placed on the conveyor. Errors in the self-checkout process may occur when a user incorrectly scans an item or omits scanning the item altogether. These errors may result in lost sales also known as “shrinkage.” In order to reduce shrinkage, cameras, scales and scanning devices may be used to detect errors in scanning or unscanned items.

### BRIEF DESCRIPTION OF THE SEVERAL VIEWS OF THE DRAWINGS

The present disclosure will be explained with reference to the following figures in which:

FIG. 1 is a diagram illustrating a point-of sale system including six self-checkout stations in accordance with some embodiments of the present disclosure.

FIG. 2 is a diagram illustrating a point-of sale system including eight self-checkout stations in accordance with some embodiments of the present disclosure.

FIG. 3 is a diagram illustrating a self-checkout station in accordance with some embodiments of the present disclosure.

FIG. 4 is a diagram illustrating a customer at a self-checkout station in accordance with some embodiments of the present disclosure.

FIG. 5 is a flow diagram illustrating a point-of-sale system in accordance with some embodiments of the present disclosure.

FIG. 6 is a basic block diagram of a data processor that can be used to process data provided through the vision mesh network in accordance with some embodiments of the present disclosure.

### DETAILED DESCRIPTION

Exemplary embodiments of the present disclosure are described in detail with reference to the accompanying drawings. The disclosure may, however, be exemplified in many different forms and should not be construed as being limited to the specific exemplary embodiments set forth herein. Rather, these exemplary embodiments are provided so that this disclosure will be thorough and complete, and will fully convey the scope of the disclosure to those skilled in the art.

Self-checkout stations at retail and grocery stores are typically installed in groups or clusters with a number of self-checkout stations being located in the same area or vicinity. Each self-checkout station generally includes numerous fixed cameras installed thereon. The cameras may be positioned to provide viewing angles of desired target areas. The target areas may include, for example, the scanner platter, the cart or hand basket, the bottom of the basket, the bagging area and the payment area. There are times when the target areas may be out of full or complete view of the respective camera, for example, a shopping cart may be placed at an angle in which the camera cannot fully see the bottom of the shopping cart. Additionally, items in the cart might be obscured by a child in the seat or by other items. These obstructions may make achieving high levels of accuracy difficult for the system, thus reducing the reliability of the system and decreasing its value.

In these situations, cameras installed on other self-checkout stations next to or near the primary self-checkout station with obstructed views may be utilized because the surrounding self-checkout stations likely have an alternate viewing angle that may be of value as an input to the primary self-checkout station's module in making an accurate determination. As used herein, other checkout stations are considered “next to or near” the primary checkout station if the other stations include a camera that is within a predetermined distance that allows one or more cameras on these other stations to provide useful information to the primary checkout station. In some embodiments, each of the self-checkout stations in a lane, group or cluster would be considered “next to or near” each other. In some embodiments, output of cameras positioned by items other than self-checkout stations may be used in accordance with embodiments of the present disclosure. For example, output of cameras positioned by doorways to monitor ingress and egress may be used. In further embodiments, cameras may be positioned throughout the store to monitor a customer's actions; output from these cameras may also be used in accordance with embodiments of the present disclosure.

Currently, a camera feed of a self-checkout station is only accessible by that particular self-checkout station. In other words, the camera feed is only available to the self-checkout station on which the camera is installed. While it is possible to centrally manage all camera data streams through a client server architecture, centrally process all inputs and then distribute the results accordingly, the increase in, for example, network resources, data security, and increased latency may present significant impedance to that type of solution.

In accordance with some embodiments of the present disclosure, a “vision mesh network” connects edge cameras of each self-checkout station directly to each other. As used herein, a “vision mesh network” refers to a group or number of cameras connected via a network, for example, a network including Wi-Fi routers, that act as a single network of cameras. Thus, there are multiple sources of data instead of just a single camera or set of cameras. By allowing access to each edge camera from all checkout stations, images or data from each edge camera can be used as data inputs for the primary self-checkout station regardless of which self-checkout station the edge camera is mounted on. This vision mesh network of edge cameras can be accessed ad-hoc to determine if there are beneficial, additional, or alternative views of target areas that can be used as additional data inputs. Information is shared amongst the vision mesh network so one camera can make a determination about a customer, checkout procedure or self-checkout station with input from some or all of the cameras in the vision mesh network. Increasing the quantity and quality of data inputs that go into a computer vision module for determining accurate operation of the self-checkout station or checkout procedure will improve the accuracy and reliability of the system.

As used herein, computer vision modules include methods for acquiring, processing, analyzing and understanding digital images, and extraction of high-dimensional data from the real world in order to form decisions. The various embodiments of computer vision modules discussed herein acquire, process, analyze and understand images and data from the vision mesh network and provide feedback and operational decisions regarding a customer, checkout procedure and/or self-checkout station. In some embodiments, the module can detect facial features of the customer to identify and authenticate the customer, determine if the customer scanned each item correctly, if personal items or retail items remain in the shopping cart or handbasket, if bags remain in the bagging station or if each item placed in a bag was scanned and purchased. In further embodiments, the module may be looking at how items are scanned and moved across the scanner platter and how a customer behaves in the bagging station.

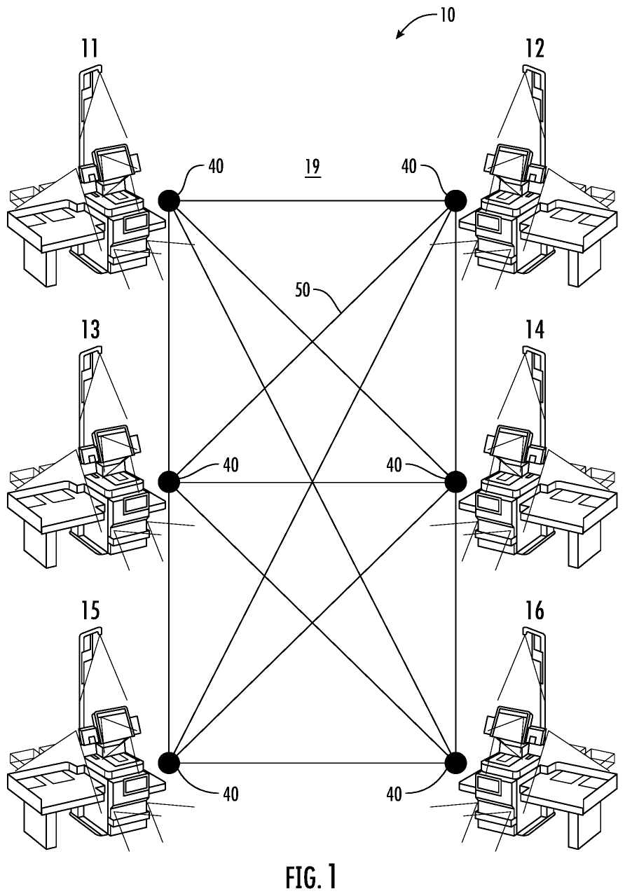

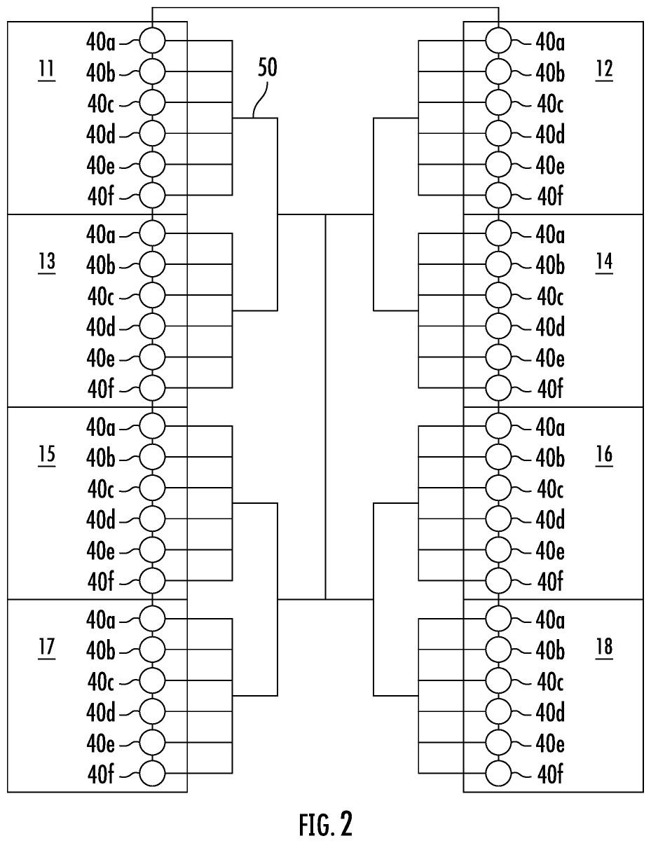

Referring first to FIGS. 1 and 2, a point-of-sale system 10 including, for example, self-checkout stations, in accordance with some embodiments of the present disclosure will be discussed. As illustrated, point-of-sale system configurations 10 may include a plurality of self-checkout stations 11, 12, 13, 14, 15, 16, 17 and 18 at a first location and in proximity to one another. The self-checkout stations 11, 12, 13, 14, 15, 16, 17 and 18 may be installed at a first location in groups or clusters near or next to one another. In some embodiments, groups may include, for example, six (FIG. 1) to eight (FIG. 2) checkout stations. The self-checkout stations may be close to one another, within a few feet of each other, evenly spaced and/or facing one another. The self-checkout stations 11, 12, 13, 14, 15, 16, 17 and 18 may be arranged on either side of a lane or aisle 19 in which customers pass through.

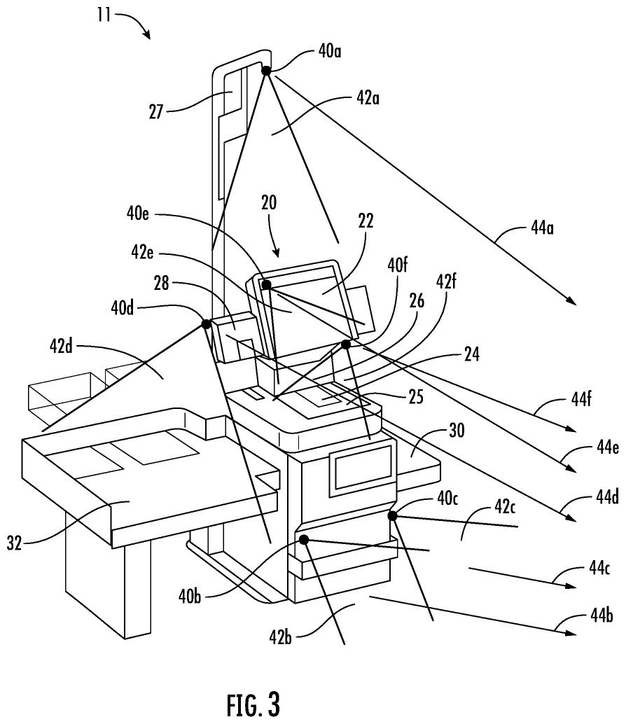

FIG. 3 illustrates an exemplary self-checkout station 11 in more detail. The station 11 includes a terminal 20, basket shelf 30 and a bagging station 32. The terminal 20 may include a customer interface, for example, a touchscreen 22, a scale 24, a scanner 26 and a payment console 28. An indicator 27, for example, a pole with a light attached to the top, may also be included to indicate when a customer needs the assistance of a store employee. A customer may initiate a transaction by pressing a “start” button or entering a loyalty number on the touchscreen 22. The scanner 26 may be used to scan items which are then placed in bagging station 32. The touchscreen 22 may be used to look up items that need to be weighed, for example, produce such as melons or apples, which are weighed on the scale 24 then placed in bagging station 32. A shelf 30 may be provided to hold a handbasket used by a customer during shopping.

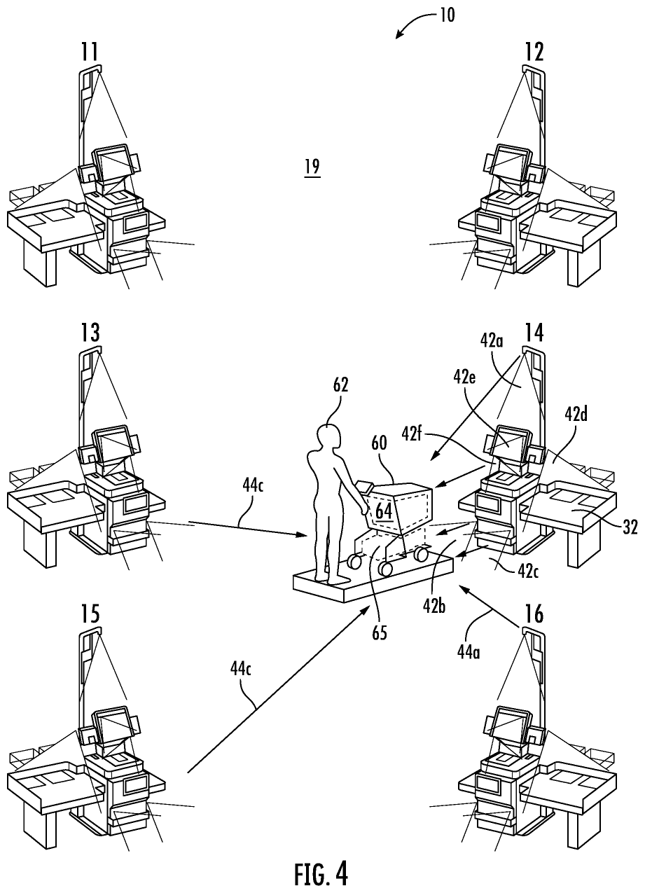

The self-checkout station 11 further includes six edge cameras 40a-f associated therewith. Each edge camera 40a-f has a corresponding primary field of view (FOV) 42a to 42f located within the checkout station 11 and a corresponding peripheral field of view 44a to 44f located outside the checkout station 11. The edge cameras 40a to 40f are mounted on the self-checkout station 11 such that the primary field of view 42a to 42f includes a desired target area. Edge camera 40a has an overhead field of view 42a which includes a target area inside a shopping cart 64 (FIG. 4) or handbasket; edge cameras 40b, 40c have fields of views 42b, 42c, that include target areas at a bottom 65 (FIG. 4) of a shopping cart; edge camera 40d has a field of view 42d that includes the bagging station 32 as a target area; edge camera 40e has a field of view 42e that includes the payment console 28 as a target area; and edge camera 40f has a field of view 42f that includes a scanner platter 25, the scale 24 and the scanner 26 as a target area. Peripheral fields of view outside of the checkout station 11 are represented by arrows 44a to 44f. The checkout stations 12 to 18 (FIGS. 1 and 2) are similar to checkout station 11 and include edge cameras 40a to 40f with corresponding primary fields of view 42a to 42f inside the respective checkout station and corresponding peripheral fields of view 44a to 44f outside the respective checkout station.

It will be understood that the systems illustrated in FIGS. 1 through 3 are provided for example only and, therefore, embodiments are not limited to the configurations shown therein. For example, there may be more or fewer self-checkout stations than illustrated, these stations may have more or fewer cameras and more or fewer features without departing from the scope of the present disclosure.

As illustrated in FIG. 1, the point-of-sale system 10 includes six checkout stations 11, 12, 13, 14, 15 and 16. Each of the checkout stations 11, 12, 13, 14, 15 and 16 includes six edge cameras 40a to 40f mounted thereon. Each of the edge cameras 40a to 40f on each of the checkout stations 11, 12, 13, 14, 15 and 16 is connected to some or all the other edge cameras 40a to 40f on the remaining checkout stations 11, 12, 13, 14, 15 and 16 to create a “vision mesh network” 50 (FIG. 1) of 36 connected edge cameras 40a to 40f. Each of the edge cameras 40a to 40f is a node on the vision mesh network. For ease and simplicity in FIG. 1, the edge cameras 40a to 40f of each of the checkout stations 11, 12, 13, 14, 15 and 16 are represented by a single node 40. In some embodiments including the embodiment shown in FIG. 1, each node 40 (edge cameras 40a to 40f) is connected to every other node 40 (edge cameras 40a to 40f) in the point-of-sale system 10. Thus, each of the edge cameras 40a to 40f is connected to the remaining thirty-five edge cameras 40a to 40f on vision mesh network 50. In the embodiment illustrated in FIG. 2, each of the self-checkout station 11, 12, 13, 14, 15, 16, 17 and 18 includes six edge cameras 40a to 40f mounted thereon. Each of the edge cameras 40a to 40f on each of the checkout stations 11, 12, 13, 14, 15, 16, 17 and 18 is a node on the vision mesh network 50 and is directly connected to every other node on the vision mesh network 50. Thus, each of the edge cameras 40a to 40f is connected to the remaining forty-seven edge cameras 40a to 40f on the vision mesh network 50. It will be understood that some or all edge cameras may be directly connected to each other on the vision mesh network without departing from the scope of the present disclosure. In one example, in another embodiment of the present disclosure, cameras from checkout stations 11 and 12 may be connected to cameras installed on checkout stations 13, 14, 15 and 16 and may not be connected to cameras installed on checkout stations 17 and 18, cameras installed on checkout stations 13, 14, 15 and 16 may be connected to cameras installed on checkout stations 11, 12, 13, 14, 15, 16, 17 and 18, and cameras from checkout stations 17 and 18 may be connected to cameras installed on checkout stations 13, 14, 15 and 16 and may not be connected to cameras installed on checkout stations 11 and 12. In another example, edge cameras 40f with a target area of the scanner platter 25, scale 24 and scanner 26 (FIG. 3) on a checkout station may not be connected to some edge cameras installed on other checkout stations.

Each of the edge cameras 40a to 40f are able to process information and perform calculations on the edge camera 40a to 40f, including analyzing images and other data, near the source of the data, i.e., at the edge camera 40a to 40f. Edge computing reduces the likelihood for the need to send images and other data to a central server or cloud service for processing which may increase processing speed and reduce stress on the overall network.

Each of the edge cameras 40a to 40f has a designated responsibility area. The edge cameras 40a to 40f feed data input, for example, images or video capture, to the designated edge camera which processes the data inputs via computer vision modules which outputs operational determinations based on the inputted data. The accuracy of the module is directly linked to the quality and quantity of input data. As discussed above, computer vision modules include methods for acquiring, processing, analyzing and understanding digital images, and extraction of high-dimensional data from the real world in order to form decisions. The various embodiments of computer vision modules discussed herein acquire, process, analyze and understand images and data from the vision mesh network and provide feedback and operational determinations regarding a customer, checkout procedure and/or self-checkout station. In some embodiments, the module can detect facial features of the customer to identify and authenticate the customer, determine if the customer scanned each item correctly, if personal items or retail items remain in the shopping cart or handbasket, if bags remain in the bagging station or if each item placed in a bag was scanned and purchased. In further embodiments, the module may be looking at how items are scanned and moved across the scanner platter and how a customer behaves in the bagging station. For this reason, a plurality of cameras 40a to 40f are installed on a single self-checkout station providing primary fields of view 42a to 42f of target areas within the respective checkout station. The target areas may include, for example, viewing the bottom of the basket to determine if there are items present and if those items have been scanned. In some instances, the target areas may be partially or completely outside of the field of view 42a to 42f of the edge camera 40a to 40f, blocked by an obstacle or not sufficiently detected to be used as a data input, thus hindering the ability of the module to make an accurate determination. The frequency of these events occurring leads to a possible reduction in module accuracy and a loss of reliability of the system and, thus, a loss of perceived value and usefulness of enhancing the functionality of a self-checkout station.

The vision mesh network 50 of FIG. 2 connects the edge cameras 40a to 40f of each of the self-checkout stations 11, 12, 13, 14, 15, 16, 17 and 18 so the edge cameras 40a to 40f can exchange images or data from any of the connected edge cameras 40a to 40f to the designated camera in the vision mesh network 50. Thus, for example, a single self-checkout station 11, illustrated in FIG. 2, with installed edge cameras 40a to 40f can make use of all six edge cameras 40a to 40f installed thereon in addition to the forty-two other edge cameras 40a to 40f installed on the remaining self-checkout stations 12, 13, 14, 15, 16, 17 and 18 in the vicinity. Thus, the vision mesh network 50 allows the system to increase the quality and quantity of data inputs by using primary images and data and peripheral images and data from the other self-checkout stations 12, 13, 14, 15, 16, 17 and 18 in order to improve results and accuracy and enhance the decision-making capabilities for self-checkout station 11.

As seen in FIG. 4, a customer 62 and a shopping cart 60 at self-checkout station 14 can be seen from self-checkout stations 13 and 15 on the opposite side of aisle 19 and from an adjacent self-checkout station 16, providing alternative views of the shopping cart 60. These peripheral views 44c, 44c, 44a, respectively, can be used to increase the accuracy of the module by increasing the quality and quantity of input data being used. In the arrangement shown in FIG. 4, the adjacent self-checkout station 16 to the right of primary self-checkout station 14 has a peripheral top view 44a of the target shopping cart 60 that can provide additional input data to the primary self-checkout station 14. Self-checkout stations 13 and 15 provide peripheral bottom views 44c of the target shopping cart 60 from the opposite side of aisle 19 and can also provide additional input data to the designated camera 40a at self-checkout station 14. The vision mesh network 50 allows the designated camera 40a to directly communicate with all other edge cameras/nodes on the vision mesh network 50. The designated edge camera 40a at the self-checkout station 14 can utilize the additional images from self-checkout stations 13, 15 and 16 as additional inputs to augment and enhance the results and determinations made regarding the customer 62, checkout procedure and self-checkout station 14. The direct communication increases the speed of data exchange ensuring that the potential multiple data inputs can be processed in real or near-time by the designated edge camera 40a without increasing network traffic, data security requirements or latency. As used herein, “real or near-time” includes the actual amount of time the customer spends at the self-checkout station and a reasonable delay which may be in the order of a few minutes. By making use of all the primary and peripheral edge cameras 40a to 40f as a mesh of data inputs, the system may increase accuracy without increasing the number of assets and costs of the system. The vision mesh network 50 expands the use of available edge cameras 40a to 40f to increase efficacy.

It will be understood that the configurations illustrated in FIGS. 1 to 4 are provided as an example only and that embodiments of the present disclosure are not limited thereto.

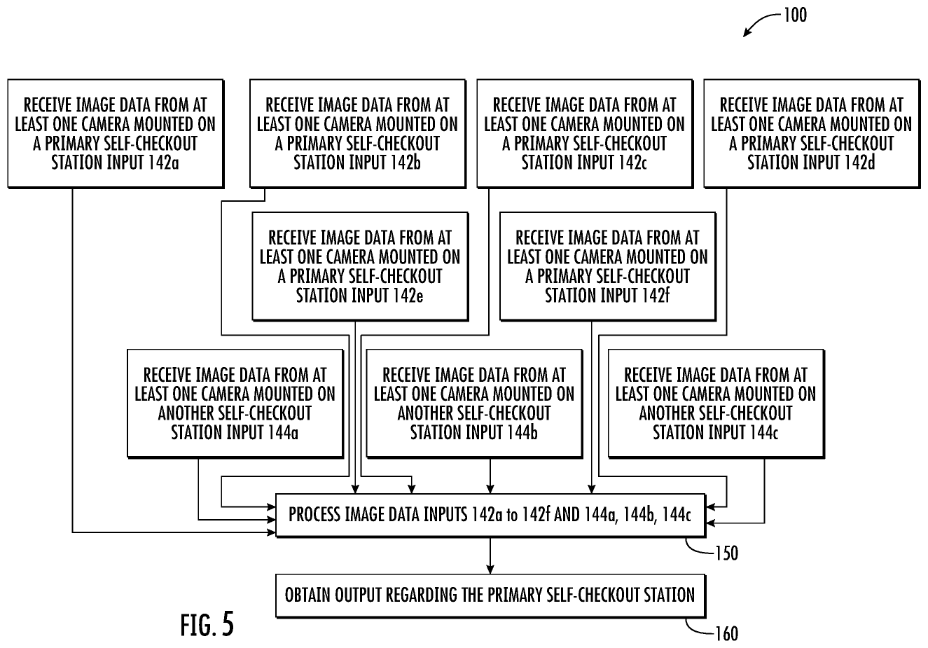

FIG. 5 illustrates a point-of-sale method 100 in accordance with an embodiment of the present disclosure. Inputs 142a, 142b, 142c, 142d, 142e, 142f concerning a checkout procedure at self-checkout station 14 (FIG. 4) are entered into a processor 150. Inputs 142a, 142b, 142c, 142d, 142e, 142f are obtained from primary views 42a to 42f of edge cameras 40a to 40f mounted on self-checkout station 14. Inputs 144a, 144b, 144c concerning the checkout procedure at self-checkout station 14 are also entered into processor 150. Inputs 144a, 144b, 144c are obtained from a peripheral view 44a of self-checkout station 16, a peripheral view 44c of self-checkout station 15 and a peripheral view 44c of self-checkout station 13, respectively (FIG. 4). Thus, inputs 144a to 144c are obtained from edge cameras mounted on other self-checkout stations 16, 15, 13 near self-checkout station 14. The image data from the nine inputs 142a, 142b, 142c, 142d, 142e, 142f, 144a, 144b, 144c are processed 150 and an output is provided 160 regarding the checkout event at self-checkout station 14.

As discussed above, some embodiments of the present disclosure provide a vision mesh network that allows data from a multitude of cameras to be shared and for the relevant data to be processed to provide an accurate outcome for the point-of-sale system. For example, the images provided using the vision mesh network may provide information to determine if all the items in a cart were scanned or scanned accurately, if a person is trying to hide an item and take it without paying and the like. Thus, some type of data processor is needed to process the data provided using the mesh network. As explained above, in accordance with an embodiment of the present disclosure, each of the edge cameras 40a to 40f are able to process information and perform calculations on the edge camera 40a to 40f, including analyzing images and other data.

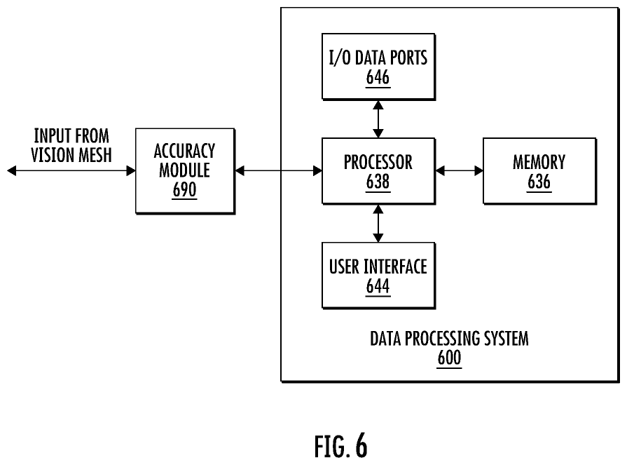

Referring now to FIG. 6, a data processor 600 in communication with an accuracy module 690 that receives inputs from the vision mesh 50 (FIGS. 1 and 2) will be discussed. It will be understood that the data processor may be included in any component of the system without departing from the scope of the present disclosure. For example, the data processor may be present in the point-of-sale system 10 (FIGS. 1 and 2) or may be centrally located. The accuracy module 690 may increase the likelihood that the point-of-sale data is accurate, for example, that all items are scanned, and items are not missed or stolen, or that each item scanned includes the proper corresponding stock-keeping unit (SKU).

As illustrated, FIG. 6 is a block diagram of an example of a data processing system 600 suitable for use in the systems in accordance with embodiments of the present disclosure. The data processing may take place in any of the devices (or all of the devices, for example, in each edge camera 40a to 40f (FIGS. 2 and 3)) in the system without departing from the scope of the present disclosure. As illustrated in FIG. 6, the data processing system 600 includes a user interface 644 such as a keyboard, keypad, touchpad, voice activation circuit or the like, I/O data ports 646 and a memory 636 that communicates with a processor 638. The I/O data ports 646 can be used to transfer information between the data processing system 600 and another computer system or a network. These components may be conventional components, such as those used in many conventional data processing systems, which may be configured to operate as described herein.

The aforementioned flow logic and/or methods show the functionality and operation of various services and applications described herein. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor in a computer system or other system. The machine code may be converted from the source code, etc. Other suitable types of code include compiled code, interpreted code, executable code, static code, dynamic code, object-oriented code, visual code, and the like. The examples are not limited in this context.

If embodied in hardware, each block may represent a circuit or a number of interconnected circuits to implement the specified logical function(s). A circuit can include any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Other types of multi-core processors and other multi-processor architectures may also be employed as part of the circuitry. According to some examples, circuitry may also include an application specific integrated circuit (ASIC) or a field programmable gate array (FPGA), and modules may be implemented as hardware elements of the ASIC or the FPGA. Furthermore, embodiments may be provided in the form of a chip, chipset or package.

Although the aforementioned flow logic and/or methods each show a specific order of execution, it is understood that the order of execution may differ from that which is depicted. Also, operations shown in succession in the flowcharts may be able to be executed concurrently or with partial concurrence. Furthermore, in some embodiments, one or more of the operations may be skipped or omitted. In addition, any number of counters, state variables, warning semaphores, or messages might be added to the logical flows or methods described herein, for purposes of enhanced utility, accounting, performance measurement, or providing troubleshooting aids, etc. It is understood that all such variations are within the scope of the present disclosure. Moreover, not all operations illustrated in a flow logic or method may be required for a novel implementation.

Where any operation or component discussed herein is implemented in the form of software, any one of a number of programming languages may be employed such as, for example, C, C++, C #, Objective C, Java, Javascript, Perl, PHP, Visual Basic, Python, Ruby, Delphi, Flash, or other programming languages. Software components are stored in a memory and are executable by a processor. In this respect, the term “executable” means a program file that is in a form that can ultimately be run by a processor. Examples of executable programs may be, for example, a compiled program that can be translated into machine code in a format that can be loaded into a random access portion of a memory and run by a processor, source code that may be expressed in proper format such as object code that is capable of being loaded into a random access portion of a memory and executed by a processor, or source code that may be interpreted by another executable program to generate instructions in a random access portion of a memory to be executed by a processor, etc. An executable program may be stored in any portion or component of a memory. In the context of the present disclosure, a “computer-readable medium” can be any medium (e.g., memory) that can contain, store, or maintain the logic or application described herein for use by or in connection with the instruction execution system.

A memory is defined herein as an article of manufacture and including volatile and/or non-volatile memory, removable and/or non-removable memory, erasable and/or non-erasable memory, writeable and/or re-writeable memory, and so forth. Volatile components are those that do not retain data values upon loss of power. Nonvolatile components are those that retain data upon a loss of power. Thus, a memory may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), or other like memory device.

The devices described herein may include multiple processors and multiple memories that operate in parallel processing circuits, respectively. In such a case, a local interface, such as a communication bus, may facilitate communication between any two of the multiple processors, between any processor and any of the memories, or between any two of the memories, etc. A local interface may include additional systems designed to coordinate this communication, including, for example, performing load balancing. A processor may be of electrical or of some other available construction.

The present disclosure provides a point-of-sale system. The point-of-sale system includes a first checkout station at a first location, a plurality of first edge cameras associated with the first checkout station, each of the plurality of first edge cameras having a first primary viewing area within the first checkout station and a first peripheral viewing area outside the first checkout station, a second checkout station at the first location, a plurality of second edge cameras associated with the second checkout station, each of the plurality of second edge cameras having a second primary viewing area within the second checkout station and a second peripheral viewing area outside the second checkout station, the second peripheral viewing area of at least one of the second edge cameras being within the first checkout station, a vision mesh network having a plurality of nodes in communication with each other, at least one of the plurality of first edge cameras and at least one of the plurality of second edge cameras being nodes within the plurality of nodes on the vision mesh network and in communication with each other. One of the plurality of first edge cameras receives and processes information about the first checkout station from the at least one second camera.

The present disclosure provides a method. The method includes acquiring information about a first checkout station with a first edge camera associated with the first checkout station, acquiring further information about the first checkout station with a second edge camera associated with a second checkout station, communicating the further information from the second edge camera to the first edge camera, and processing the information and the further information to obtain a result about the first checkout station

The present disclosure provides a non-transitory computer-readable medium storing computer executable instructions that when executed by one or more processors cause the one or more processors to acquire information about a first checkout station with a first edge camera associated with the first checkout station, acquire further information about the first checkout station with a second edge camera associated with a second checkout station, communicate the further information from the second edge camera to the first edge camera, and process the information and the further information to obtain a result about the first checkout station.

It should be emphasized that the above-described embodiments of the present disclosure are merely possible examples of implementations set forth for a clear understanding of the principles of the disclosure. It is, of course, not possible to describe every conceivable combination of components and/or methodologies, but one of ordinary skill in the art may recognize that many further combinations and permutations are possible. That is, many variations and modifications may be made to the above-described embodiment(s) without departing substantially from the spirit and principles of the disclosure. All such modifications and variations are intended to be included herein within the scope of this disclosure and protected by the following claims.

In the present disclosure, reference is made to a “Point-Of-Sale (POS) system.” As used herein, the term “POS system” refers to any system that is used to process transactions at a retail store or other business, including self-checkout (SCO) systems where individuals can scan, pay for, or bag their own items. POS systems are used for a variety of purposes, such as completing sales transactions, processing returns, or handling inquiries. POS systems can be found in a variety of settings, including traditional brick-and-mortar retail stores, online stores, and mobile sales environments. It will be understood that as used herein POS systems include more than one checkout system adjacent to or near other like systems having cameras associated therewith.

In the present disclosure, reference is made to “checkout procedure.” As used herein, the term “checkout procedure” is used broadly to refer to any part of a process for carrying out a transaction at a retail location, such as on a point-of-sale system or self-checkout station. The specific steps involved in a checkout procedure may vary depending upon the retailer or the type of point-of-sale system or self-checkout station being used. For example, a checkout procedure can include, but is not limited to, scanning a loyalty card, canning items, weight the items, obtaining item qualities, quantities and/or dimensions, processing a payment for an item, or printing or emailing a receipt. Checkout procedures can be carried out by a human cashier or a self-checkout station.

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. It will be further understood that the terms “comprises,” “comprising,” “includes” and/or “including”, “have” and/or “having” when used herein, specify the presence of stated features, integers, steps, operations, elements, and/or components, but do not preclude the presence or addition of one or more other features, integers, steps, operations, elements, components, and/or groups thereof. Elements described as being “to” perform functions, acts and/or operations may be configured to or other structured to do so. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which various embodiments described herein belong. It will be further understood that terms used herein should be interpreted as having a meaning that is consistent with their meaning in the context of this specification and the relevant art and will not be interpreted in an idealized or overly formal sense unless expressly so defined herein.

While the foregoing is directed to aspects of the present disclosure, other and further embodiments of the disclosure may be devised without departing from the basic scope thereof, and the scope thereof is determined by the claims that follow.

What is claimed is:

1. A point-of-sale system comprising:
a first checkout station at a first location;
a plurality of first edge cameras associated with the first checkout station, each of the plurality of first edge cameras having a first primary viewing area within the first checkout station and a first peripheral viewing area outside the first checkout station;
a second checkout station at the first location;
a plurality of second edge cameras associated with the second checkout station, each of the plurality of second edge cameras having a second primary viewing area within the second checkout station and a second peripheral viewing area outside the second checkout station, the second peripheral viewing area of at least one of the second edge cameras being within the first checkout station;
a vision mesh network having a plurality of nodes in communication with each other, at least one of the plurality of first edge cameras and at least one of the plurality of second edge cameras being nodes within the plurality of nodes on the vision mesh network and in communication with each other; and
one of the plurality of first edge cameras receiving and processing information about the first checkout station from the at least one second camera.

2. The point-of-sale system of claim 1, wherein the first peripheral viewing area of at least one of the first cameras is located within the second checkout station.

3. The point-of-sale system of claim 1, wherein the one first camera receives information from the plurality of first cameras and the at least one second camera.

4. The point-of-sale system of claim 3, wherein the information includes images.

5. The point-of-sale system of claim 3, wherein the one first camera receives information from the plurality of first cameras and the plurality of second cameras.

6. The point-of-sale system of claim 1, wherein the information includes images.

7. The point-of-sale system of claim 1, wherein each of the plurality of first edge cameras and each of the plurality of second edge cameras are nodes within the plurality of nodes on the vision mesh network and in communication with each other.

8. The point-of-sale system of claim 1, further comprising:
a third checkout station located at the first location;
a plurality of third edge cameras associated with the third checkout station, each of the plurality of third edge cameras having a third primary viewing area within the third checkout station and a third peripheral viewing area outside the third checkout station, the third peripheral viewing area of at least one of the third edge cameras being within the first checkout station;
a fourth checkout station at the first location;
a plurality of fourth edge cameras associated with the fourth checkout station, each of the plurality of fourth edge cameras having a fourth primary viewing area within the fourth checkout station and a fourth peripheral viewing area outside the fourth checkout station, the fourth peripheral viewing area of at least one of the fourth edge cameras being within the first checkout station;
at least one of the plurality of third edge cameras and at least one of the plurality of fourth edge cameras being nodes on the vision mesh network and in communication with each other; and
the one first camera receiving and processing information about the first checkout station from at least one of the third edge cameras and at least one of the fourth edge cameras.

9. The point-of-sale system of claim 8, further comprising two to four more checkout stations at the first location.

10. The point-of-sale system of claim 8, wherein each of the plurality of first edge cameras, each of the plurality of second edge cameras, each of the plurality of third edge cameras and each of the plurality of fourth edge cameras are nodes within the plurality of nodes on the vision mesh network and in communication with each other.

11. The point-of-sale system of claim 1, wherein the first primary viewing area includes a target.

12. The point-of-sale system of claim 11, wherein the target includes a scanner platter, a scale, a scanner, a shopping cart, a handbasket, a bagging area or a payment area.

13. The point-of-sale system of claim 1, wherein the plurality of first edge cameras are fixed on the first checkout station.

14. The point-of-sale system of claim 13, wherein the plurality of second edge cameras are fixed on the second checkout station.

15. The point-of-sale system of claim 1, wherein the plurality of first edge cameras are located within the first checkout station and the plurality of second edge cameras are located within the second checkout station.

16. A method comprising:
acquiring information about a first checkout station with a first edge camera associated with the first checkout station;
acquiring further information about the first checkout station with a second edge camera associated with a second checkout station;
communicating the further information from the second edge camera to the first edge camera; and
processing the information and the further information to obtain a result about the first checkout station.

17. The method of claim 16, wherein the information and further information include images.

18. The method of claim 16, wherein the first edge camera and the second edge camera are nodes on a vision mesh network, the first edge camera being communicatively connected to the second edge camera.

19. The method of claim 16, wherein the first edge camera receives and processes the information and the further information.

20. A non-transitory computer-readable medium storing computer executable instructions that when executed by one or more processors cause the one or more processors to:
acquire information about a first checkout station with a first edge camera associated with the first checkout station;
acquire further information about the first checkout station with a second edge camera associated with a second checkout station;
communicate the further information from the second edge camera to the first edge camera; and
process the information and the further information to obtain a result about the first checkout station.
